(19) United States
(12) Patent Application Publication
(10) Pub. No.: US 2024/0124184 A1
(43) Pub. Date: Apr. 18, 2024

(54) SHRINK WRAPPED ROLL OF PAPER TOWELS HAVING A DISPENSING MECHANISM

(71) Applicant: KCooper Brands, Inc., Aurora, CO (US)

(72) Inventor: George W. Dempsey, Aurora, CO (US)

(21) Appl. No.: 18/489,546

(22) Filed: Oct. 18, 2023

Related U.S. Application Data
(60) Provisional application No. 63/417,213, filed on Oct. 18, 2022.

(51) Int. Cl. B65C 3/06; A47K 10/38

(52) U.S. Cl. CPC B65C 3/065; A47K 10/38

(57) ABSTRACT

A dispenser for a roll of paper products is disclosed. The dispenser is formed of shrink wrap and information about the paper products is printed directly on the shrink wrap. A label is placed on either end of the shrink wrap dispenser. The label conforms to the shape of the roll of paper products and also adds rigidity to the dispenser. The label defines an orifice or aperture through which the paper products are dispensed. The orifice is pre-perforated to enable the orifice to be easily opened. The orifice assists a user in dispensing a single paper product from the roll of paper products.

### CROSS-REFERENCE TO RELATED APPLICATIONS

The present application is a non-provisional application of, and claims priority to, U.S. Provisional Patent Application No. 63/417,213 filed Oct. 18, 2022 and titled “Shrink Wrapped Roll of Paper Towels Having a Dispensing Mechanism”, the entire disclosure of which is hereby incorporated by reference in its entirety.

### BACKGROUND

Various paper products, such as, for example, paper towels, moist towelettes and the like, are typically dispensed from a dispenser. The shape of the dispenser typically matches the shape of the paper product to be dispensed. For example, a continuous roll of paper towels is typically dispensed from a round or circular dispenser. In another example, paper towels may be pre-cut, folded and stacked and dispensed from a rectangular or square dispenser.

The dispenser is typically formed from a hard plastic, cardboard or other rigid material or a loose-fitting bag. These rigid dispensers typically include a rigid flip top lid that closes or otherwise seals the dispenser. When the dispenser is a loose-fitting bag, the dispenser typically includes a zip seal. However, dispensers such as these are costly to produce and generate a lot of waste.

### SUMMARY

The present application describes a process for preparing a roll (e.g., round/circular) of paper products to be dispensed from dispenser. The dispenser may be comprised of a shrink wrap, shrink film or other polymer plastic film. In an example, information about the paper products may be printed directly on the shrink wrap thereby eliminating the need to include additional material within or on the shrink wrap dispenser.

In an example, a label may be placed on either end of the shrink wrap dispenser. The label conforms to the shape of the roll of paper products and also adds rigidity to the entire structure. The label may define an orifice or aperture through which the paper products are dispensed. In an example, the orifice may or may not be resealable. The orifice may be pre-perforated to enable the orifice to be easily opened. The orifice may take any shape such as, for example, a multi-pointed star, an “X”, and cyclone shape, etc. The orifice may assist a user in dispensing a single paper product from the roll of paper products. For example, the orifice may have a shape that enables a first part of the orifice to dispense a paper product while a second part of the orifice can grab or hold a portion of the paper product while the individual tears the paper product (e.g., via a plurality of perforations).

In an example, the roll of paper products may be dry paper towels or wet/moistened paper towels/wipes. In an example, the roll of paper products is coreless (e.g., is not wrapped around a center dowel or core). As such, each paper product may be dispensed from the center.

Accordingly, examples of the present disclosure describe a label for a shrink wrap paper product dispenser. In an example, the label includes a first substantially planar side and a second substantially planar side opposite the first substantially planar side. In an example, the second substantially planar side includes an adhesive for coupling the label to the shrink wrap. The label also includes one or more perforations for an orifice. The orifice includes a first portion and a second portion in which the second portion is more narrow when compared to the first portion. In an example, the label also includes a semi-rigid label closure for puncturing the one or more perforations of the orifice and for subsequent sealing of the orifice.

In yet another example, the present application describes a dispenser for a paper product. The dispenser includes a shrink wrap encasing a center dispense paper product roll. In an example, the shrink wrap has a first rigidity. The dispenser also includes a label provided on a top surface of the shrink wrap. In an example, the label has a second rigidity that is more rigid when compared to the first rigidity. The label also includes a first substantially planar side and a second substantially planar side opposite the first substantially planar side. The label also includes a semi-rigid label closure for forming an aperture having a first portion and a second portion. The second portion is more narrow when compared to the first portion.

Still other examples describe a dispenser for a paper product that includes a plastic film encasing a product roll and having a first rigidity a label having a second rigidity that is more rigid when compared to the first rigidity. In an example, the label includes a semi-rigid label closure for forming an aperture in at least a portion of the label. In an example, the aperture has a first portion and a second portion in which the second portion is more narrow when compared to the first portion.

### BRIEF DESCRIPTION OF THE DRAWINGS

Non-limiting and non-exhaustive examples are described with reference to the following Figures.

FIG. 1A is a top view of a roll of paper towels according to an example.

FIG. 1B is a perspective view of the roll of paper towels shown and described with respect to FIG. 1A according to an example.

FIG. 2A illustrates the roll of paper towels being provided in a shrink wrap dispenser according to an example.

FIG. 2B illustrates a bottom view of a semi-rigid label closure for a label according to an example.

FIG. 3A illustrates a label and corresponding orifice or aperture that may be provided on one or both ends of a dispenser for a roll of paper towels according to a first example.

FIG. 3B illustrates a label and corresponding orifice or aperture that may be provided on one or both ends of a dispenser for a roll of paper towels according to a second example.

FIG. 3C illustrates a label and corresponding orifice or aperture that may be provided on one or both ends of a dispenser for a roll of paper towels according to a third example.

FIG. 3D illustrates a label and corresponding orifice or aperture that may be provided on one or both ends of a dispenser for a roll of paper towels according to a fourth example.

FIG. 4 illustrates a method for packing a roll of paper towels according to an example.

FIG. 5 illustrates a method for dispensing a paper towel from a dispenser according to an example.

### DETAILED DESCRIPTION

In the following detailed description, references are made to the accompanying drawings that form a part hereof, and in which are shown by way of illustrations, specific embodiments or examples. These aspects may be combined, other aspects may be utilized, and structural changes may be made without departing from the present disclosure. The following detailed description is therefore not to be taken in a limiting sense, and the scope of the present disclosure is defined by the appended claims and their equivalents.

As outlined above, paper products such as, for example, paper towels, dry and moist towelettes and the like, are typically dispensed from a dispenser. The shape of the dispenser typically matches the shape of the paper product to be dispensed. For example, a continuous roll of paper towels is typically dispensed from a round or circular dispenser. In another example, paper towels may be pre-cut, folded and stacked and dispensed from a rectangular or square dispenser.

Typically, the dispenser is typically formed from a hard plastic, cardboard or other rigid material. These rigid dispensers typically include a rigid flip top lid that closes or otherwise seals the dispenser. However, dispensers such as these are costly to produce and generate a lot of waste. Additionally, the rigid flip top lid does not always create a tight enough seal that prevents contamination and/or prevents moist towelettes from drying out.

Accordingly, the present application describes a center dispense rolled paper product (e.g., dry paper towels, wet/moist paper towels or wipes) provided in a dispenser. In an example, the dispenser is comprised of a shrink wrap, a shrink film or other polymer plastic film. Information about the paper product is printed directly on the shrink wrap thereby eliminating the need to include additional materials on or within the shrink wrap dispenser. One or more rigid or semi-rigid labels are provided on a proximal and/or distal end of the rolled paper product to add rigidity to the dispenser. The label may include or otherwise define an orifice that assists an individual in dispensing a single paper product from the roll of paper products. The label may also include a semi-rigid label closure that may be used to cover, perforate the and/or expose the orifice.

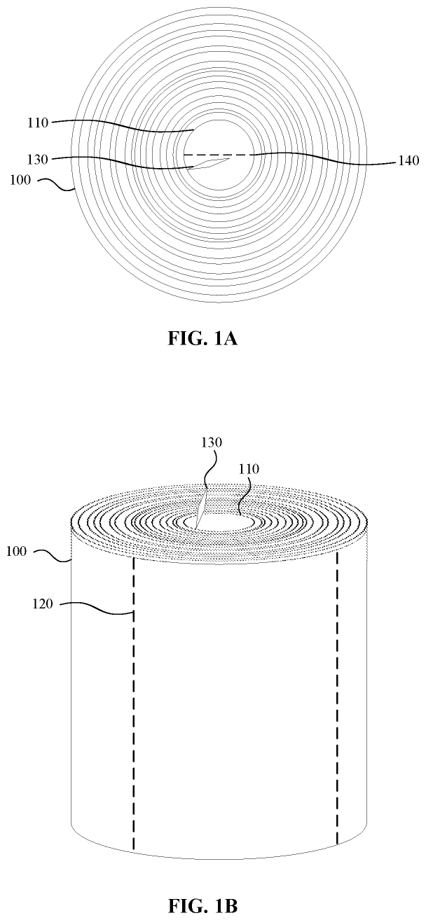

These and other features will be described in more detail with respect to FIG. 1A-FIG. 5.

FIG. 1A is a top view of a roll of paper towels 100 according to an example. In some examples, the roll of paper towels 100 are dry. In other examples, the roll of paper towels 100 are wet/moist. In an example, the roll of paper towels 100 are made from different materials and/or have different qualities, grades and/or gauges. For example, the roll of paper towels 100 may be DRC (e.g., pulp with a binder). In another example, the roll of paper towels 100 may be a thin layer of plastic with pulp or rayon fibers. In yet another example, the roll of paper towels 100 is a rolled fabric made of either natural fibers or combined with films or threads of plastic.

In the example shown in FIG. 1A, the roll of paper towels 100 is coreless or is otherwise configured to dispense paper towels from the center 110 of the roll of paper towels 100. For example and as shown in FIG. 1A, an edge or side of one paper towel 130 may extend from the center 110 of the roll of paper towels 100. As such, an individual may grab the edge of the paper towel 130 and pull outward/upward to remove the paper towel 130 from the center of the roll of paper towels 100.

In an example, the roll of paper towels 100 is a continuous roll. As such, an individual may tear a length of paper towel 130 from the roll of paper towels 100. In another example and as shown in FIG. 1B, the roll of paper towels 100 includes a plurality of perforations 120 that enable the paper towel 130 in the roll of paper towels 100 to be separated from an adjacent paper towel.

During a manufacturing process, the roll of paper towels 100 is rolled such that the roll of paper towels 100 is round or substantially round. In some examples, rolling the roll of paper towels 100 reduces manufacturing time and cost when compared with other methods of preparing paper towels to be provided in a dispenser (e.g., folding and/or cutting). As indicated above, the roll of paper towels is coreless.

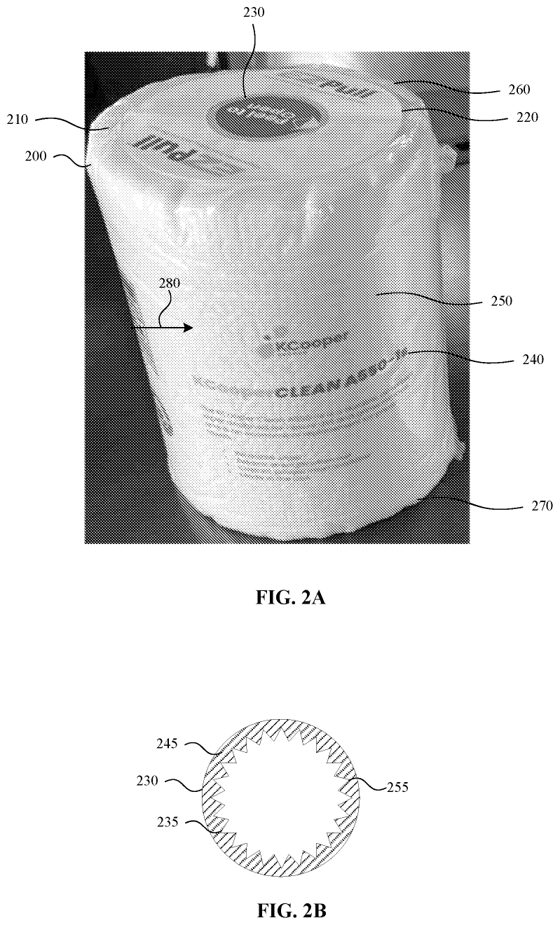

FIG. 2A illustrates a roll of paper towels 200 being provided in a dispenser 210. In an example, the roll of paper towels 200 is similar to the roll of paper towels 100 shown and described with respect to FIG. 1A. In the example shown, the dispenser 210 is a shrink wrap, a shrink film or another polymer plastic film. Information 240 about the contents of the dispenser 210 may be printed directly on the dispenser 210 during production. This eliminates the need for adding extra labels on or within the body 250 of the dispenser 210.

In some examples, a label 220 is provided on a proximal end 260 and/or a distal end 270 of the dispenser 210. The label 220 may have a first diameter, while the dispenser 210 and/or the roll of paper towels 200 may have a second, different (e.g., larger) diameter. In another example, the label and the dispenser 210 and/or the roll of paper towels 200 may have the same or a similar diameter.

In an example, the label 220 is formed from a rigid or a semi-rigid material (e.g., a plastic) that provides structure to the dispenser 210. For example, the dispenser 210 has a first rigidity and the label 220 has a second, greater rigidity when compared with the rigidity of the dispenser 210.

In an example, the label 220 includes an adhesive or other material that secures the label 220 to the dispenser 210. The label 220 may be secured on an outer surface of the dispenser 210 and/or an inner surface of the dispenser 210. Although a circular label 220 is shown, the label 220 may have any shape.

As indicated above, the label 220 provides structure to the dispenser 210. As such, the label 220 may have a thickness of approximately two millimeters (mm) to five mm, although other dimensions (e.g., between one mm and 10 mm (or more) may be used. For example, the thickness of the label 220 may vary based on the material that is used for the dispenser 210 and/or the material used for the roll of paper towels 200. Additionally, the material for the label 220, the dispenser 210 and/or the roll of paper towels 200 may change depending on the product and/or whether there is a need for multi-layer packaging.

Because the label 220 is rigid, the label 220 prevents the dispenser 210 from collapsing in on itself (e.g., in the direction of arrow 280) as paper towels are removed from the roll of paper towels 200.

In some examples, film that comprises the dispenser 210, the label 220 and/or the adhesive on the label 220 include an anti-microbial coating. This coating prevents mold from growing within and/or on the dispenser 210 and/or on the roll of paper towels 200.

As also shown in FIG. 2A, the label 220 includes a semi-rigid (e.g., plastic) label closure 230. In an example, the semi-rigid label closure 230 has a third rigidity. The third rigidity may be greater than the rigidity of the dispenser 210 but less than the rigidity of the label 220.

The semi-rigid label closure 230 may be integrated with the label 220 such that the label 220 and the semi-rigid label closure 230 form a single, unitary piece. In another example, the semi-rigid label closure may be separable and/or removable from the label 220.

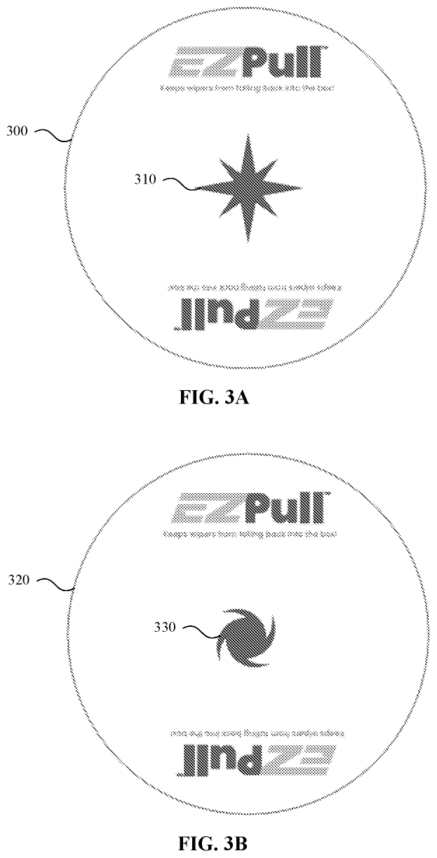

The semi-rigid label closure 230 is used to cover and/or expose an orifice or aperture in the label 220. The semi-rigid label closure 230 may be made from a flexible/bendable plastic or other material and may be repeatedly peeled from, and secured to, the label 220. The orifice is defined by the label 220 and may take a number of different shapes such as will be described below with respect to FIG. 3A-FIG. 3C.

In some examples, and as shown in FIG. 2B, the semi-rigid label closure 230 includes a rigid (e.g., plastic) member 235 provided on a bottom surface of the semi-rigid label closure 230. In an example, the rigid member 235 have a fourth rigidity. In an example, the fourth rigidity may be more rigid when compared to the rigidity of the dispenser 210 and/or the semi-rigid label closure 230. However, the fourth rigidity may less rigid, more rigid, or have the same rigidity, as the label 220.

The rigid member 235 may extend from the bottom surface of the semi-rigid label closure 230 and be used to puncture or otherwise open the label 220 and/or the dispenser 210. In an example, the rigid member 235 may include a cutting feature 255 that enables the rigid member to puncture the label 220 and/or the dispenser 210. The cutting feature may include points, teeth, serrations and the like.

In an example, the rigid member 235 has the desired shape of the orifice. Thus, when the semi-rigid label closure 230 is provided on the label 220 and a downward force or pressure is applied, the semi-rigid label closure 230 punctures, cuts or otherwise causes an opening to be formed on the label 220 and/or the dispenser 210, which subsequently enables paper towels to be dispensed through the punctured orifice.

In some examples, the semi-rigid label closure 230 may be completely removable from the label 220. In another example, the semi-rigid label closure 230 may include an adhesive that enables the semi-rigid label closure 230 to act as a seal. In examples in which the semi-rigid label closure 230 includes the rigid member, the rigid member may be removeable from the semi-rigid label closure 230.

The semi-rigid label closure 230 may also include an adhesive 245 that enables the semi-rigid label closure 230 to be removed from, and subsequently closed over, the orifice or aperture in the label 220 and/or the dispenser 210.

FIG. 3A illustrates a label 300 and corresponding orifice 310 or aperture that may be provided on one or both ends of a dispenser for a roll of paper towels according to a first example. In an example, the label 300 may be similar to the label 220 shown and described with respect to FIG. 2A. The label 300 may have a diameter of approximately 4 inches to approximately seven inches although other diameters may be used.

In the example shown in FIG. 3A, the orifice 310 has a star shape. For example, a first portion (e.g., a center) of the orifice 310 is wider than a second portion (e.g., the arms or protrusions extending from the center) of the orifice 310.

In an example, the first portion of the orifice 310 enables a paper towel to pass through while the second portion of the orifice 310 acts to secure one end of the paper towel for subsequent dispensing. In order to assist with the dispensing and/or tearing of one paper towel from an adjacent paper towel, the second portion of the orifice 310 may have “teeth” or other cutting mechanisms. This configuration enables a one-hand application in which an individual may grab an exposed end of a paper towel, pull upward so that the paper towel extends through the first portion of the orifice 310, and subsequently pull the paper towel toward one of the second portions of the orifice 310 to assist with tearing the dispensed paper towel from an adjacent paper towel while simultaneously or substantially simultaneously preparing a subsequent paper towel for dispensing.

In an example, the material that makes up the orifice 310 (e.g., before the orifice 310 is punctured by the rigid member (e.g., the rigid member 235 (FIG. 2B)) of the semi-rigid label closure (e.g., the semi-rigid label closure 230 (FIG. 2B))), may be a different material from the label 300. As such, the orifice may be more easily puncturable when compared with the material that comprises the label 300. In another example, the orifice 310 and the label 300 may be made from a similar material. However, in this example, the orifice 310 may include perforations that enable the rigid member to more easily puncture the orifice 310 when compared with the label 300.

FIG. 3B illustrates a label 320 and corresponding orifice 330 or aperture that may be provided on one or both ends of a dispenser for a roll of paper towels according to a second example and FIG. 3C illustrates a label 340 and corresponding orifice 350 that may be provided on one or both ends of a dispenser for a roll of paper towels according to a third example. Each of the labels and corresponding orifices shown in these figures may function in a similar manner as the orifice 310 and label 300 shown and described with respect to FIG. 3A. Although specific shapes are shown, the orifices may have any shape in which a first portion of the orifice is wider than a second portion of the orifice such as described above.

FIG. 3D illustrates a label 360 and a corresponding orifice 370 or aperture that may be provided on one or both ends of a dispenser for a roll of paper towels according to a fourth example. In this example, the orifice 370 includes perforations 375 which may enable the orifice 370 to be more easily formed in the label and/or the dispenser. Additionally, the label 360 includes an adhesive 380 which enables the label 360 to be adhered to the dispenser.

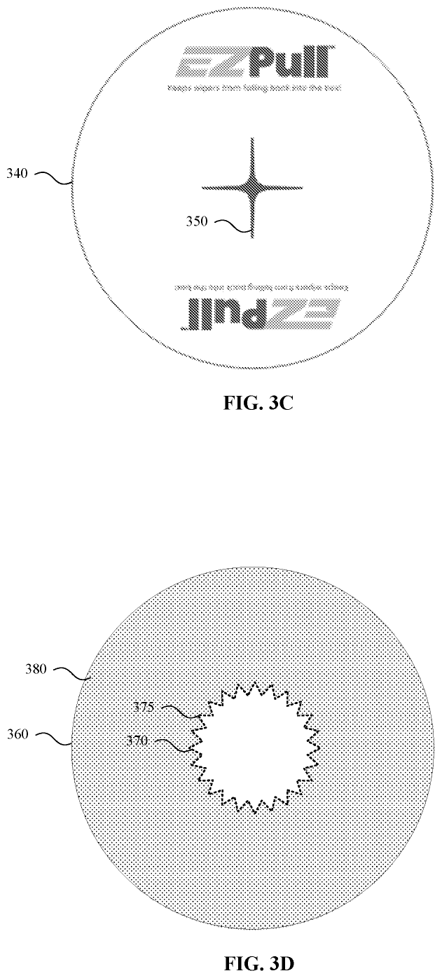

FIG. 4 illustrates a method 400 for packing a roll of paper towels according to an example. In an example, the method 400 may be used to produce the roll of paper towels 200 shown and described with respect to FIG. 2.

Method 400 begins when a roll of paper towels is formed (410). In an example, the roll of paper towels may be rolled or otherwise formed to have a hollow center. As such, the roll of paper towels may be dispensed from the center. In another example, the roll of paper towels may be dispensed from an edge or side.

The roll of paper towels is then encased (420) in a dispenser. In an example, the dispenser is a shrink wrap, a shrink film or another polymer plastic film. Additionally, information about the contents of the dispenser may be printed directly on the film which eliminates the need for adding extra labels on or within the body of the dispenser.

When the roll of paper towels is encased in the dispenser, the dispenser may be sealed and one or more labels are adhered (430) or otherwise secured to one or more surfaces of the dispenser. In an example, the one or more labels are adhered or otherwise secured on a top surface of the dispenser and/or on a bottom surface of the dispenser. In another example, the label may be placed on a side surface of the dispenser. In the later example, the paper towels may be dispended from an edge and rotate or roll within the dispenser.

In examples in which labels are provided on a proximal surface and/or a distal surface of the dispenser, the roll of paper towels may remain stationary or substantially stationary (e.g., the roll of paper towels does not rotate or otherwise has minimal movement) when the paper towels are subsequently dispensed.

As previously explained, the label is formed from a rigid or a semi-rigid material (e.g., a plastic) that provides structure to the dispenser to the flimsier dispenser. Thus, when compared to the dispenser, the label is more rigid.

In an example, the label includes an adhesive or other material that secures the label to the dispenser. Although an adhesive is mentioned, other means for securing the label to the dispenser may be used. Additionally, the label may be secured on an outer surface of the dispenser and/or an inner surface of the dispenser. Additionally, the label may have any shape and/or dimensions.

As also previously explained, because the label is more rigid when compared with to the dispenser, the label provides structure to the dispenser. As such, the label prevents the dispenser from collapsing in on itself as paper towels are removed from the roll of paper towels.

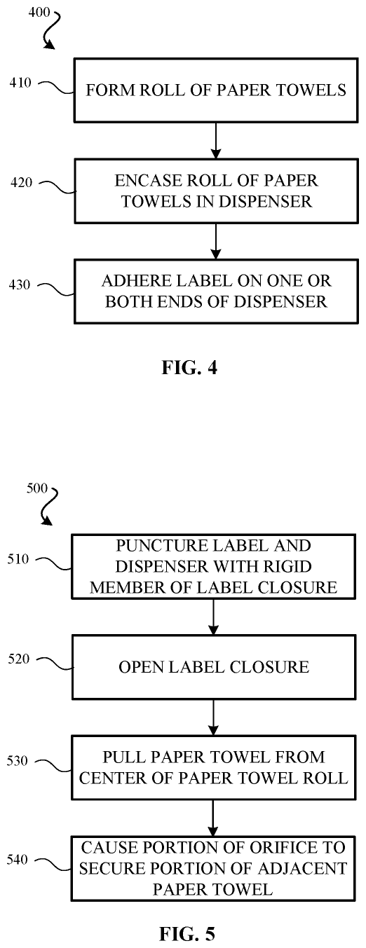

FIG. 5 illustrates a method 500 for dispensing a paper towel from a dispenser according to an example. The method 500 may be performed on a roll of paper towels such as, for example, the roll of paper towels 200 provided in a dispenser 210 shown and described with respect to FIG. 2.

Method 500 begins when a label and/or a dispenser that encases the roll of paper towels is punctured (510). In an example, the puncture is formed in the label and/or in the dispenser by a rigid member of a label closure. For example, the rigid member of the label closure may puncture or otherwise form an opening in the label and/or the dispenser when a downward force or pressure is applied. In an example, the rigid member may be serrated, be formed in a point (or multiple points) and/or sharpened which enables the rigid member to puncture the label and/or the dispenser.

Once the label and/or the dispenser has been punctured, a paper towel may be pulled (530) from a center of the roll. At least a portion of the paper towel (or at least a portion of an adjacent paper towel) may then be secured to a portion of the orifice from which the paper towel is dispensed. The paper towel may then be torn or otherwise removed from the roll of paper towels.

The description and illustration of one or more aspects provided in the present disclosure are not intended to limit or restrict the scope of the disclosure in any way. The aspects, examples, and details provided in this disclosure are considered sufficient to convey possession and enable others to make and use the best mode of claimed disclosure.

The claimed disclosure should not be construed as being limited to any aspect, example, or detail provided in this disclosure. Regardless of whether shown and described in combination or separately, the various features (both structural and methodological) are intended to be selectively rearranged, included or omitted to produce examples with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

References to an element herein using a designation such as “first,” “second,” and so forth does not generally limit the quantity or order of those elements. Rather, these designations may be used as a method of distinguishing between two or more elements or instances of an element. Thus, reference to first and second elements does not mean that only two elements may be used or that the first element precedes the second element. Additionally, unless otherwise stated, a set of elements may include one or more elements.

Terminology in the form of “at least one of A, B, or C” or “A, B, C, or any combination thereof” used in the description or the claims means “A or B or C or any combination of these elements.” For example, this terminology may include A, or B, or C, or A and B, or A and C, or A and B and C, or 2A, or 2B, or 2C, or 2A and B, and so on. As an additional example, “at least one of: A, B, or C” is intended to cover A, B, C, A-B, A-C, B-C, and A-B-C, as well as multiples of the same members. Likewise, “at least one of: A, B, and C” is intended to cover A, B, C, A-B, A-C, B-C, and A-B-C, as well as multiples of the same members.

Similarly, as used herein, a phrase referring to a list of items linked with “and/or” refers to any combination of the items. As an example, “A and/or B” is intended to cover A alone, B alone, or A and B together. As another example, “A, B and/or C” is intended to cover A alone, B alone, C alone, A and B together, A and C together, B and C together, or A, B, and C together.

What is claimed is:

1. A label for a shrink wrap paper product dispenser, comprising:
a first substantially planar side;
a second substantially planar side opposite the first substantially planar side, the second substantially planar side including an adhesive for coupling the label to the shrink wrap;
one or more perforations for an orifice, the orifice having a first portion and a second portion, the second portion being more narrow when compared to the first portion; and
a semi-rigid label closure for puncturing the one or more perforations of the orifice and for subsequent sealing of the orifice.

2. The label of claim 1, wherein the semi-rigid label closure includes an adhesive.

3. The label of claim 1, wherein the label has a first rigidity and the dispenser has a second rigidity that is less rigid when compared with the first rigidity.

4. The label of claim 1, wherein the label has a thickness of between one millimeter and ten millimeters.

5. The label of claim 1, wherein the label has a diameter that is equivalent to a diameter of the shrink wrap paper product dispenser.

6. The label of claim 1, wherein the label has a diameter that is less than a diameter of the shrink wrap paper product dispenser.

7. The label of claim 1, wherein the adhesive enables the label to be provided on an inside surface of the dispenser.

8. The label of claim 1, wherein the adhesive enables the label to be provided on an outside surface of the dispenser.

9. A dispenser for a paper product, comprising:
shrink wrap encasing a center dispense paper product roll, the shrink wrap having a first rigidity; and
a label provided on a top surface of the shrink wrap, the label having a second rigidity that is more rigid when compared to the first rigidity, the label comprising:
a first substantially planar side;
a second substantially planar side opposite the first substantially planar side; and
a semi-rigid label closure for forming an aperture having a first portion and a second portion, the second portion being more narrow when compared to the first portion.

10. The dispenser of claim 9, further comprising an adhesive for coupling the label to the shrink wrap.

11. The dispenser of claim 9, wherein the label includes a plurality of perforations in a shape of the aperture.

12. The dispenser of claim 9, wherein the semi-rigid label closure includes an adhesive.

13. The dispenser of claim 9, wherein the label has a thickness of between one millimeter and ten millimeters.

14. The dispenser of claim 9, wherein the label has a diameter that is equivalent to a diameter of the dispenser.

15. The dispenser of claim 9, wherein the label has a diameter that is less than a diameter of the dispenser.

16. The dispenser of claim 9, wherein the adhesive enables the label to be provided on an inside surface of the dispenser.

17. The dispenser of claim 9, wherein the adhesive enables the label to be provided on an outside surface of the dispenser.

18. The dispenser of claim 9, wherein the semi-rigid label closure has a rigidity that is greater than the first rigidity and less than the second rigidity.

19. The dispenser of claim 9, wherein the semi-rigid label closure includes a rigid member for forming the aperture.

20. A dispenser for a paper product, comprising:
a plastic film encasing a product roll and having a first rigidity; and
a label having a second rigidity that is more rigid when compared to the first rigidity, the label comprising:
a semi-rigid label closure for forming an aperture in at least a portion of the label, the aperture having a first portion and a second portion, the second portion being more narrow when compared to the first portion.
